(19) United States
(12) Patent Application Publication
(10) Pub. No.: US 2025/0045931 A1
(43) Pub. Date: Feb. 6, 2025

(54) IMAGE MEASURING APPARATUS AND PROGRAM

(71) Applicant: MITUTOYO CORPORATION, Kawasaki (JP)

(72) Inventors: Hiroyuki Yoshida, Kanagawa (JP); Yuji Sadahira, Kanagawa (JP); Yuki Yamasaki, Kanagawa (JP); Yoshitaka Izumi, Kanagawa (JP)

(21) Appl. No.: 18/788,366

(22) Filed: Jul. 30, 2024

(30) Foreign Application Priority Data
Aug. 1, 2023 (JP) 2023-125246
Jun. 25, 2024 (JP) 2024-102435

(51) Int. Cl. G06T 7/13; G01B 11/03

(52) U.S. Cl. CPC G06T 7/13; G01B 11/03

(57) ABSTRACT

An image measuring apparatus, according to the present invention, captures an image of the measurement object and measures the dimensions of the measurement point of the measurement object by analyzing the image. The image measuring apparatus comprises: a display unit that displays the image of the measurement object; an input unit that accepts input of the trajectory traced by an operator on the image displayed on the display unit; an edge detection unit that detects an edge based on the traced trajectory on the image; and a measurement performing unit that performs measurement based on one or more detected edges.

### CROSS-REFERENCE TO RELATED APPLICATION

This non-provisional application claims priorities under 35 U.S.C. § 119(a) from Japanese Patent Application No. 2023-125246, filed on Aug. 1, 2023, and Japanese Patent Application No. 2024-102435, filed on Jun. 25, 2024, the entire contents of which are incorporated herein by reference.

### BACKGROUND OF THE INVENTION

### Field of the Invention

The present invention relates to an image measuring apparatus and program enabling efficient edge detection.

### Description of the Related Art

An image measuring apparatus is a device that captures an image of a measurement object and measures the dimensions of the measurement point of the measurement object by analyzing the image (see, for example, JP2010-169584A).

### SUMMARY OF THE INVENTION

### Problems to be Solved by the Invention

Conventionally, during image measurement, the operator selects an edge of the measurement object in the image of the measurement object and applies an edge detection tool appropriate to the shape of the edge to perform edge detection. And, for example, when measuring the length dimension between two edges, two edges are detected, and then the length dimension between the edges is measured. This means that the selection of edges from the image, application of the edge detection tool, and detection of two or more edges must be repeated with detailed confirmation of edge positions.

The object of the present invention is to provide an image measuring apparatus and a program that can reduce the workload of edge detection.

### Means for Solving the Problems

An image measuring apparatus according to the present invention captures an image of the measurement object and measures the dimensions of the measurement point of the measurement object by analyzing the image. The image measuring apparatus comprises: a display unit that displays the image of the measurement object; an input unit that accepts input of the trajectory traced by an operator on the image displayed on the display unit; an edge detection unit that detects an edge based on the traced trajectory on the image; and a measurement performing unit that performs measurement based on one or more edges detected by the edge detection unit.

The edge detection unit may detect the edge that exists in the area along the centerline of the trajectory.

The edge detection unit may detect the edge that exists within the area surrounded by the trajectory.

The edge detection unit may detect the edge that is similar in shape to the shape of the trajectory.

The edge detection unit may determine whether or not the shape similar to the point cloud data of the trajectory is a straight line by least-squares fitting a straight line to the point cloud data of the trajectory and calculating RMSE (Root Mean Squared Error). If it is determined that the shape similar to the point cloud data of the trajectory is not a straight line, the edge detection unit may determine whether the shape similar to the point cloud data of the trajectory is a circle or a circular arc by least-squares fitting a circle to the point cloud data of the trajectory and calculating RMSE (Root Mean Squared Error). If it is determined that the shape similar to the point cloud data of the trajectory is a circle or a circular arc, the edge detection unit may determine whether the shape similar to the point cloud data of the trajectory is a circle or a circular arc by calculating the distance between the center of gravity of the point cloud data of the trajectory and the center of the optimal circle, which is a circle that is least-squares fitted to the point cloud data of the trajectory.

The point cloud data of the trajectory may be the point cloud data of a thin line obtained by thinning the image of the trajectory using a thinning algorithm.

If a shape similar to the point cloud data of the trajectory is identified as a straight line, then among the straight lines in a predefined detection area based on the trajectory in the image of the measurement object, straight lines whose angle with the optimal straight line, which is a least-squares fitted line to the point cloud data of the trajectory, is less than or equal to a predetermined threshold value are extracted. Then, among the extracted straight lines, a base straight line may be determined based on a predefined rule, and among the extracted straight lines other than the base straight line, those whose length of the perpendicular line descending from the midpoint to the extension of the base straight line is less than or equal to a predetermined threshold value are connected to the base straight line and the resulting straight line may be detected as an element for edge detection.

If a shape similar to the point cloud data of the trajectory is identified as a circle, then among circles in a predefined detection area based on the trajectory in the image of the measurement object, circles where the distance between the center of the circle and the center of the optimal circle is less than or equal to a predetermined threshold may be extracted, and the circle to be an element for edge detection may be determined among the extracted circles based on a predefined rule.

If a shape similar to the point cloud data of the trajectory is identified as a circular arc, or if a shape similar to the point cloud data of the trajectory is identified as a circle and there is no circle in the predefined detection area based on the trajectory for which the distance between the center of the circle and the center of the optimal circle is less than or equal to a predetermined threshold value, then among circular arcs in a predefined detection area based on the trajectory in the image of the measurement object, circular arcs where the distance between the center of the circle including the circular arc and the center of the optimal circle is less than or equal to a predetermined threshold value may be extracted. Then, among the extracted circular arcs, a base circular arc may be determined based on a predefined rule, and among the extracted circular arcs other than the base circular arc, those whose difference between the radius of the circle including the circular arc and the radius of the circle including the base circular arc is less than or equal to a predetermined threshold value are connected to the base circular arc and the resulting circular arc or circle may be detected as the element for edge detection.

The edge detection unit may perform edge detection when the input of the trajectory to the input unit is terminated.

The edge detection unit may perform detection of undetected edges at each certain stretch of the trajectory during the ongoing input of the trajectory to the input unit.

The display unit may be a touch panel display integrated with the input unit.

The functions of the image measuring apparatus of the present invention may be described in a program, and the functions of the image measuring apparatus of the present invention may be realized by making a computer execute the program.

### Effect of the Invention

According to the image measuring apparatus and program of the present invention, edges can be detected by an intuitive operation in which the operator traces the image displayed on the display, thereby reducing the workload of edge detection.

### BRIEF DESCRIPTION OF THE DRAWINGS

FIG. 1 shows an example of the appearance of an image measuring apparatus 1.

FIG. 2 is a schematic diagram showing the internal structure of the image measuring apparatus 1.

FIG. 3 shows a functional block diagram of the image measuring apparatus 1.

FIG. 4 shows an example of an image of the measurement object.

FIG. 5 is a diagram showing how the image of the measurement object is traced.

FIG. 6 shows an example of the display of detected edges.

FIG. 7 is another diagram showing how the image of the measurement object is traced.

FIG. 8 shows another example of the display of detected edges.

FIG. 9 shows an example of the display of measurement results.

FIG. 10 illustrates the case where the entire shape of the measurement object cannot be traced.

FIG. 11 illustrates how to deal with cases where the entire shape of the measurement object cannot be traced.

FIGS. 12A to 12F illustrate how to deal with lacking or protruding parts in the shape of the measurement object.

FIGS. 13A and 13B illustrate a method for acquiring point cloud data of a trajectory.

FIGS. 14A to 14C illustrate a method for identifying the shape of the trajectory.

FIGS. 15A to 15E illustrate the element detection procedure when the identified shape is a straight line.

FIGS. 16A to 16E illustrate the element detection procedure when the identified shape is a circular arc.

FIGS. 17A to 17D illustrate the element detection procedure when the identified shape is a circle and circles are extracted from the detection area.

FIGS. 18A to 18E illustrate the element detection procedure when the identified shape is a circle and circular arcs are extracted from the detection area.

FIGS. 19A to 19D illustrate the procedure for detecting individual elements when a plurality of elements are traced with a single stroke.

FIGS. 20A to 20D illustrate the procedure for detecting a single element when the single element is traced by dividing it into a plurality of parts.

FIG. 21 illustrates the procedure for detecting individual elements when a plurality of trajectories are input in batches.

### DETAILED DESCRIPTION OF THE EMBODIMENTS

Hereinafter, embodiments of the present invention will be described with reference to the drawings. In the following description and drawings, the same reference numeral is attached to the same functional parts, and the functional parts, once explained, are either omitted or explained to the extent necessary.

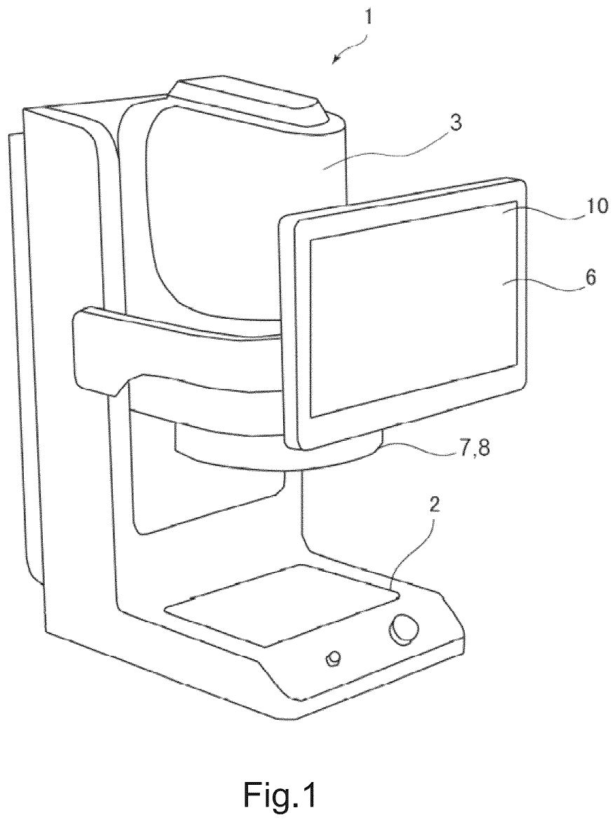

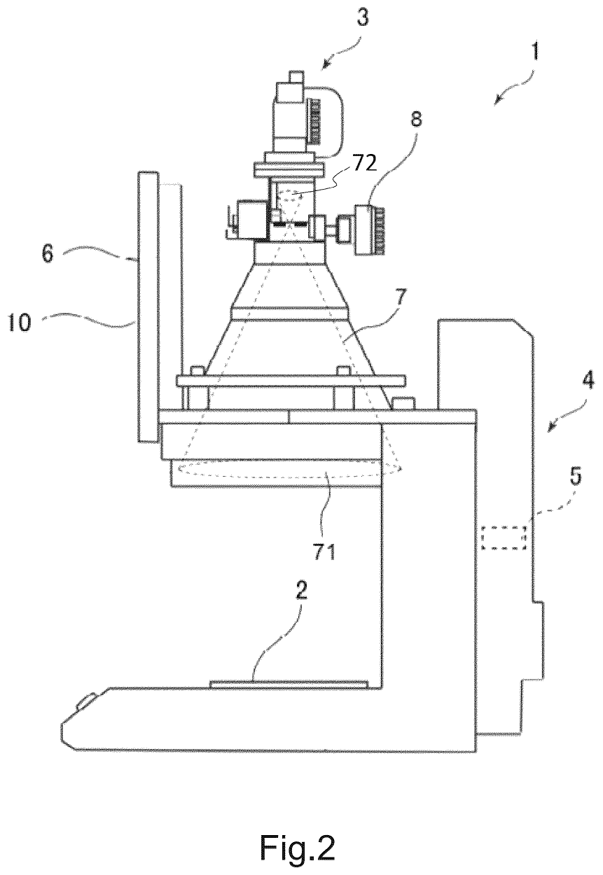

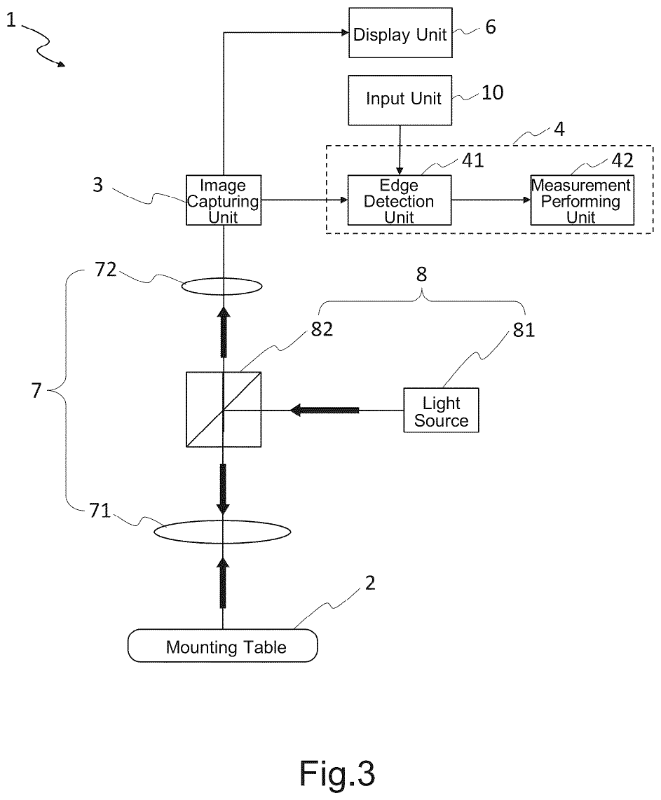

FIG. 1 is a schematic diagram showing an example of the appearance of an image measuring apparatus 1. FIG. 2 is a schematic diagram showing the internal structure of the image measuring apparatus 1. FIG. 3 shows a functional block diagram of the image measuring apparatus 1. In the present embodiment, the case in which the coaxial episcopic illumination is adopted as the illumination method will be explained as an example, but any illumination method is acceptable as long as the image of the measurement object can be captured.

The image measuring apparatus 1 includes a mounting table 2, an image capturing unit 3, control processing unit 4, a memory unit 5, a display unit 6, a telecentric optical system 7, an illumination unit 8, and an input unit 10.

The mounting table 2 is a platform on which a measurement object (not shown in the drawings) is placed.

The image capturing unit 3 is disposed opposite the mounting table 2 and captures images of the measurement object mounted on the mounting table 2 by receiving light from the direction of the mounting table 2. The image capturing unit 3 includes an image sensor, which converts the brightness or darkness of an image formed on its light-receiving surface into an electrical signal, thereby generating image data. For the image sensor, a semiconductor solid-state imaging device such as CCD (Charge-Coupled Device) or CMOS (Complementary Metal Oxide Semiconductor) is used.

The memory unit 5 is an arbitrary storage means capable of storing digital data.

The display unit 6 is an arbitrary display means, and displays the image of the measurement object captured by the image capturing unit 3 etc.

The telecentric optical system 7 includes an objective lens 71 that collects light from the direction of the mounting table 2 and an imaging lens 72 that forms an image of the light arriving through the objective lens 71 on the light-receiving surface of the image capturing unit 3. The objective lens 71 and the imaging lens 72 may have a plurality of lens surfaces, respectively.

The illumination unit 8 is a coaxial episcopic illumination means provided with a light source 81 that emits illumination light and a beam splitter 82 that interrupts the illumination light from the light source 81 into the telecentric optical system 7 and directs the light toward the mounting table 2 as coaxial episcopic illumination light whose optical axis coincides with that of the image capturing unit 3. The illumination unit 8 may be equipped with transillumination or side illumination in addition to the coaxial episcopic illumination for image clarity and other purposes.

The input unit 10 accepts input of the trajectory traced by an operator on the image of the measurement object displayed on the display unit 6. For example, if a touch panel display, in which the unit is integrally configured with the display unit 6, is applied, the input unit 10 accepts input of the trajectory traced by the operator with his/her finger. If a mouse is applied, the input unit 10 accepts input of the trajectory of the pointer as the operator moves it.

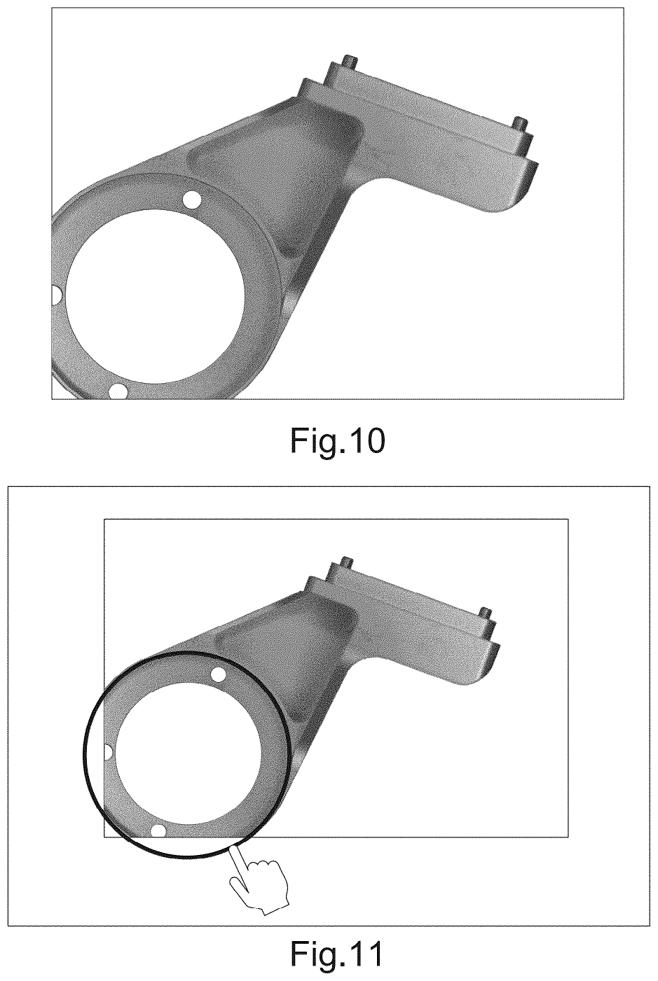

If a part of the measurement object is not included in the image, as shown in FIG. 10, and the entire shape of the object cannot be traced because the object is too large, the image may be reduced, and the resulting display margins may be used to accept an overall shape input by virtually tracing a portion of the contour that is not included in the image as shown in FIG. 11. In this case, since the virtually traced portion is less accurate in tracing the shape, the RMSE calculation described later may be performed by weighting the point cloud data within the range of the image.

If part of a line or circle is lacking, as in the examples shown in FIGS. 12A and 12B, it may be traced continuously, including the lacking part, as in the examples shown in FIGS. 12C and 12D.

If part of a line or circle has a protruding part, as in the example shown in FIG. 12E, it may be traced continuously as if there is no protruding part, as in the example shown in FIG. 12F.

The control processing unit 4 controls each part in the image measuring apparatus 1 and performs necessary arithmetic processing to realize image capture and image measurement by the image measuring apparatus 1.

In the present invention, the control processing unit 4 includes an edge detection unit 41 and a measurement performing unit 42.

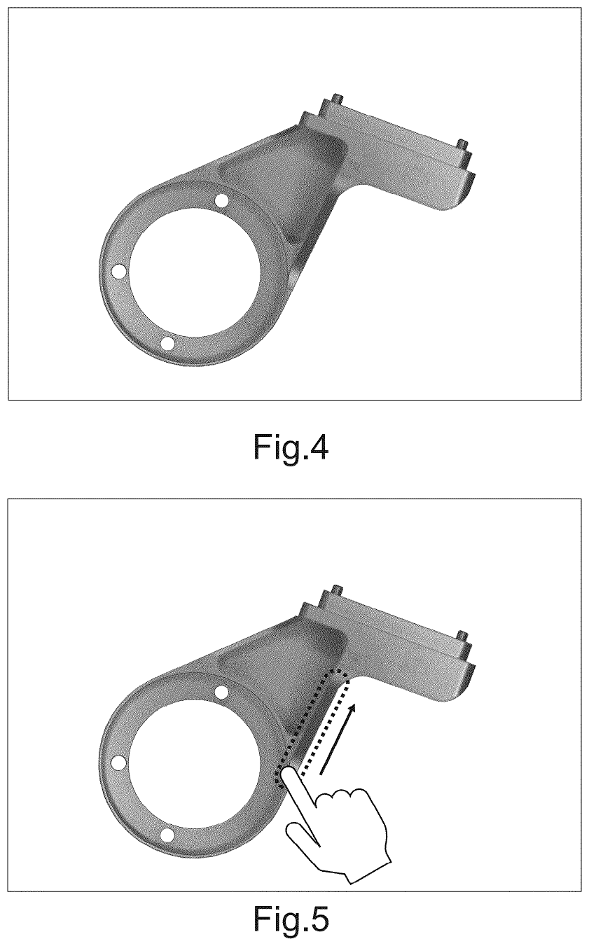

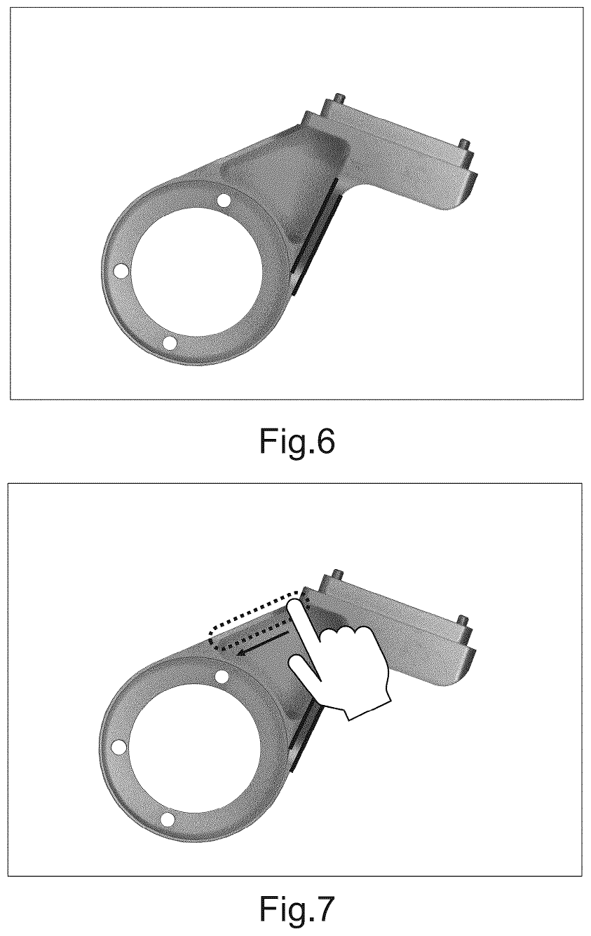

The edge detection section 41 detects edges based on the traced trajectory on the image of the measurement object displayed on the display unit 6, which is accepted by the input unit 10. The detected edges may be superimposed on the image of the measurement object. For example, when there is an image of a measurement object shown in FIG. 4, if the portion of this image where the edge is to be detected is traced as shown in FIG. 5, the edge is detected as shown in FIG. 6.

The traced trajectory may be used as-is as an edge detection area, or, for example, an area along the center line of the trajectory, or more specifically, an area of a certain width from the center line of the trajectory, may be used as the detection area. Alternatively, the area surrounded by the trajectory may be used as the detection area. By setting the detection area as the area surrounded by the trajectory, for example, edges can be detected collectively when they exist in concentric circles.

Edges can be detected more accurately by applying a detection and processing method appropriate to the shape of the edges to be detected. Therefore, edge detection unit 41 identifies the shape of the traced trajectory as one of the most similar shapes, such as a straight line, a circular arc, or a circle. The shape of the trajectory is specified by fitting the point cloud data of the trajectory to a straight line and circle.

The point cloud data of the trajectory may be obtained, for example, as the point cloud data PC of the trajectory T traced by a finger or mouse pointer, as shown in FIG. 13A. When traced with a finger, the trajectory T has a width, so it may be obtained, for example, as point cloud data of the trajectory of the coordinates of the midpoint in the width direction or of the coordinates of the center of gravity of the area of finger contact. In addition, the point cloud data can be obtained from a trajectory image created separately using paint software, etc. In this case, since coordinate data cannot be obtained, the point cloud data may be obtained by thinning the trajectory image M using the Zhang-Suen algorithm, etc., and converting the resulting thin line TL into point cloud data, as shown in FIG. 13B.

The point cloud data of the trajectory acquired in this way is fitted to a straight line and circle, for example, by the following procedure, and classified into any of the shapes based on statistical processing. In order to improve the accuracy of the fitting, outliers may be removed by random sample consensus (RANSAC) prior to the fitting.

First, a straight line is fitted to the point cloud data by least-squares fitting, and then the line RMSE, which is the RMSE (Root Mean Squared Error: the error value indicated by the root mean square of the residuals) at that time, is calculated. This may be converted to a line RMSE per unit length by dividing the line RMSE by the length of the straight line fitted to the point cloud data (hereinafter referred to as the “optimal straight line”). When the line RMSE calculated in this way is less than or equal to a predetermined value, it is determined that the shape similar to the trajectory is a straight line.

If the line RMSE is greater than a predetermined value, a circle is fitted to the point cloud data by least-squares fitting, and the circle RMSE, which is the RMSE at that time, is calculated. This may be converted to a circle RMSE per unit radius by dividing the circle RMSE by the radius of the circle fitted to the point cloud data (hereinafter referred to as the “optimal circle”). When the circle RMSE calculated in this way is less than or equal to a predetermined value, it is determined that the shape similar to the trajectory is a circle or a circular arc. On the other hand, if the circle RMSE is greater than the predetermined value, the trajectory shape is determined to be other than a straight line, a circle, or a circular arc.

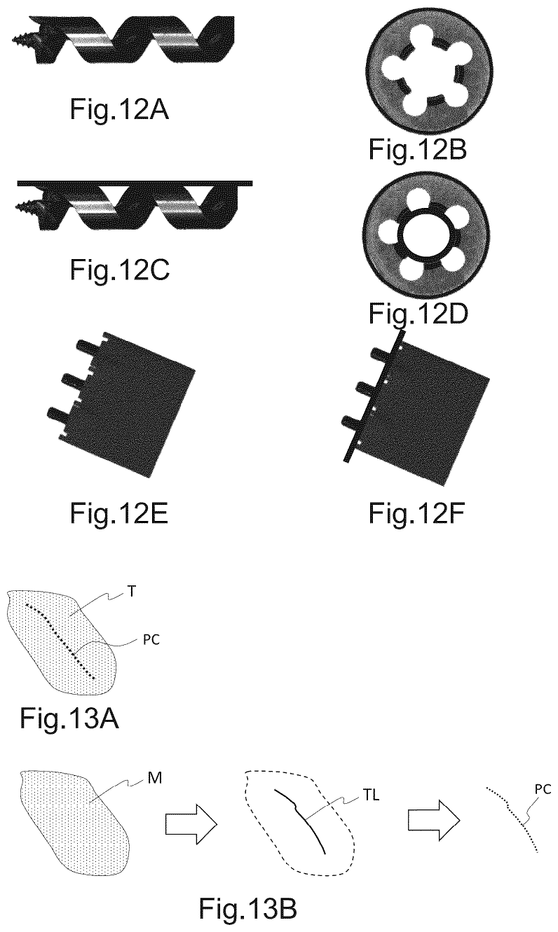

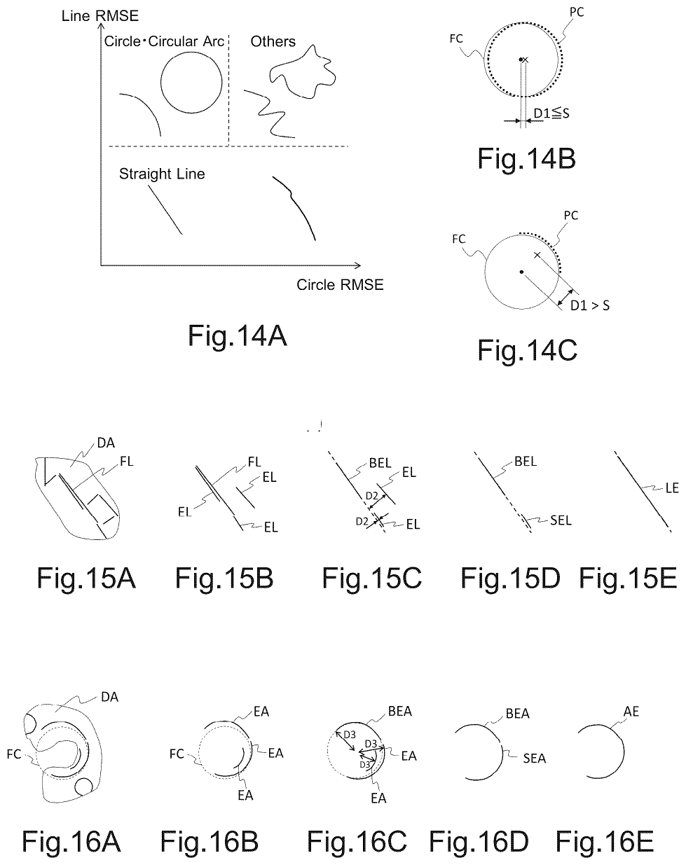

FIG. 14A summarizes the rules for classifying shapes similar to the point cloud data of the trajectory into straight lines, circles or circular arcs, and others, according to the values of the line RMSE and circle RMSE.

If it is determined that the shape similar to the trajectory is a circle or a circular arc, it is further determined whether the distance between the center of gravity of the point group data and the center of the optimal circle is less than a predetermined distance. Alternatively, it may be determined by whether the ratio of the distance between the center of gravity of the point cloud data and the center of the optimal circle to the radius of the optimal circle is less than a predetermined value. When the distance is less than or equal to the predetermined distance or when the ratio is less than or equal to the predetermined value, the shape of the trajectory is determined to be a circle. Otherwise, the shape of the trajectory is determined to be a circular arc. For example, as shown in FIG. 14B, if the distance D1 between the center of gravity of the point cloud data PC and the center of the optimal circle FC is less than the predetermined distance S, the shape that the point cloud data PC is similar to is determined to be a circle. As shown in FIG. 14C, if the distance D1 between the center of gravity of the point cloud data PC and the center of the optimal circle FC is greater than the predetermined distance S, the shape that the point cloud data PC is similar to is determined to be a circular arc.

The edge of the identified shape is then detected from the image of the detection area by applying the detection processing method corresponding to the identified shape. At this time, if there is a plurality of edges corresponding to the identified shape, the plurality of edges may be detected. The example in FIG. 6 shows two edges detected. When there is a plurality of edges that correspond to the identified shape, only those edges with a higher similarity to the identified shape may be detected. If the edges are intermittent but form an identified shape as a whole, they may be detected as a one-piece edge of the identified shape.

For example, a certain area along the optimal straight line or optimal circle, or a range of images of the trajectory, is defined as the detection area, and the edges of the identified shape are detected by the following procedure.

If the identified shape is a straight line, first, among straight lines in the predefined detection area DA shown in FIG. 15A in the image of the measurement object, straight lines whose angle with the optimal straight line FL is less than a predetermined threshold value are extracted, as shown in FIG. 15B. Then, among the extracted straight lines (hereinafter referred to as “extracted straight lines EL”), the base straight line (hereinafter referred to as “base straight line BEL”) is determined by a predefined rule, as shown in FIG. 15C. The base straight line BEL is determined based on, for example, the length of the straight line or its proximity to the optimal straight line. Then, for each of the extracted straight lines other than the base straight line, the length D2 of the perpendicular line descending from the midpoint to the extension of the base straight line is calculated, and the extracted straight line SEL with length D2 less than or equal to a predetermined threshold is identified, as shown in FIG. 15D. The extracted straight line SEL is then connected to the base straight line BEL and detected as the straight line element LE for edge detection, as shown in FIG. 15E. When connecting, the extracted straight line SEL to be connected is moved to the extension of the base straight line BEL, and if there is a gap between the extracted straight line SEL and the base straight line BEL, the gap is complemented and the extracted straight line SEL is connected to the base straight line BEL. Then, a straight line edge detection tool is applied to the detected straight line element LE to detect edges.

If the detection area includes a plurality of straight line elements, a plurality of base straight lines may be determined, and for each base straight line, the distance between the extracted straight line and the base straight line may be calculated. Then, the straight line obtained by connecting the extracted straight line whose distance is less than or equal to the threshold value to the base straight line may be detected as the element.

If the identified shape is a circular arc, first, among the circular arcs in the predefined detection area DA in the image of the measurement object shown in FIG. 16A, circular arcs where the distance between the center of the circle including the circular arc and the center of the optimal circle FC is less than or equal to a predetermined threshold value are extracted as shown in FIG. 16B. Then, among the extracted circular arcs (hereinafter referred to as “extracted circular arc EA”), the base circular arc (hereinafter referred to as “base circular arc BEA”) is determined based on a predefined rule, as shown in FIG. 16C. The base circular arc BEA is determined based on, for example, the length of the arc, its proximity to the center of the optimal circle FC, or the smallest difference between the radius of the circle including the extracted circular arc and the radius of the optimal circle FC. Then, among the extracted circular arcs other than the base circular arc BEA, the extracted circular arc SEA with the difference D3 between the radius of the circle including the extracted circular arc EA and the radius of the circle including the base circular arc is less than or equal to a predetermined threshold value is identified as shown in FIG. 16D. The extracted circular arc SEA is then connected to the base circular arc BEA and detected as the circular arc element AE for edge detection, as shown in FIG. 16E. When connecting, the extracted circular arc SEA to be connected is moved onto the circle that includes the base circular arc BEA, and if there are gaps between the extracted circular arc SEA and the base circular arc BEA, the gaps other than the largest gap are complemented to connect them. Then, a circular arc edge detection tool is applied to the detected circular arc element AE to detect edges.

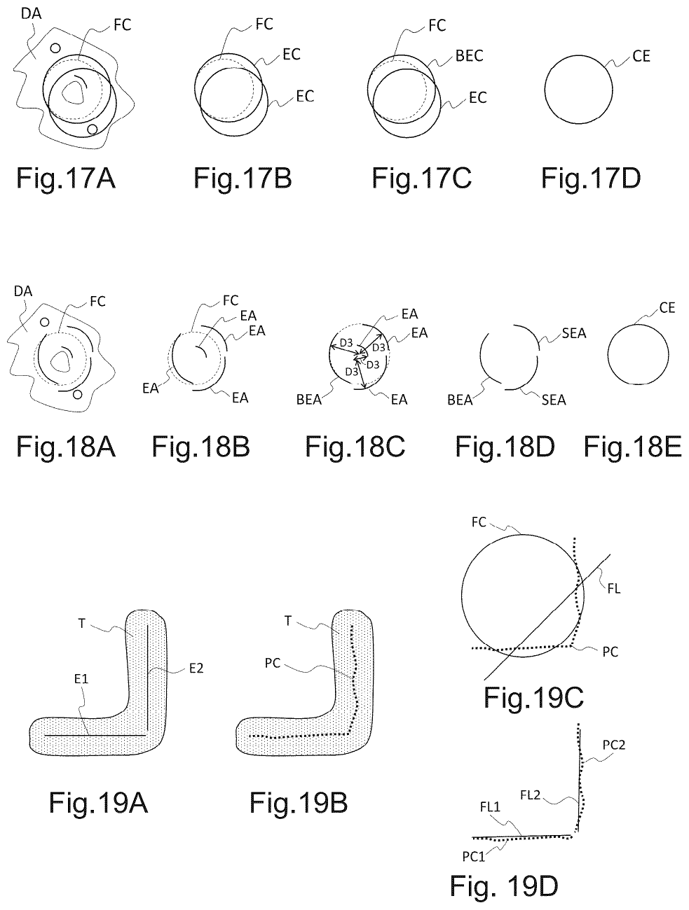

If the identified shape is a circle, first, among the circles and circular arcs in the predefined detection area DA in the image of the measurement object shown in FIG. 17A or FIG. 18A, circles where the distance between the center of the circle and the center of the optimal circle FC is less than or equal to a predetermined threshold value, or a circular arc where the distance between the center of the circle including the circular arc and the center of the optimal circle FC is less than or equal to a predetermined threshold value are extracted.

If circles are extracted as shown in FIG. 17B, among the extracted circles (hereinafter referred to as “extracted circle EC”), the base circle (hereinafter referred to as “base circle BEC”) is determined based on a predefined rule, as shown in FIG. 17C. The base circle BEC is determined based on, for example, its proximity to the center of the optimal circle FC or the smallest difference in radius from the optimal circle FC. The base circle BEC is then detected as the circular element CE for edge detection, as shown in FIG. 17D, and the circular edge detection tool is applied to this circular element CE to detect edges.

If no circle is extracted and circular arcs are extracted as shown in FIG. 18B, the base circular arc BEA is determined among the extracted circular arcs EA based on a predefined rule as shown in FIG. 18C. The base circular arc BEA is determined based on, for example, the length of the arc, its proximity to the center of the optimal circle FC, or the smallest difference between the radius of the circle including the extracted circular arc and the radius of the optimal circle FC. Then, among the extracted circular arcs other than the base circular arc BEA, the extracted circular arc SEA with the difference D3 between the radius of the circle including the extracted circular arc EA and the radius of the circle including the base circular arc is less than a predetermined threshold value is identified as shown in FIG. 18D. The extracted circular arc SEA is then connected to the base circular arc BEA and detected as the circular element CE for edge detection, as shown in FIG. 18E. When connecting, the extracted circular arc SEA to be connected is moved onto the circle that includes the base circular arc BEA, and if there is a gap between the extracted circular arc SEA and the base circular arc BEA, the gap is complemented to connect them. Then, a circular edge detection tool is applied to the detected circular element CE to detect edges.

If the detection area includes a plurality of circular or arc-shaped edges, a plurality of base circles or base circular arcs may be determined, and if the base circles can be determined, each of the determined base circles may be detected as the element for edge detection. If the base circular arcs can be determined, for each base circular arc, the extracted circular arc whose difference between the radius of the circle including the extracted circular arc and the radius of the circle including the base circular arc is less than or equal to a threshold value may be connected to the base circular arc, and the resulting circle or circular arc may be detected as the element for edge detection.

Even if several elements in a row are traced with a single stroke, it is possible to detect individual elements. For example, when each point in the point cloud data obtained by tracing is fitted to each shape, for each point, it is evaluated whether or not the residual with the model estimated by RANSAC is located within the threshold value. If the number of points within the threshhold value is less than a predetermined number, the point cloud data is divided using the binary tree method etc., and each divided set of point cloud data is fitted to each shape and evaluated by RANSAC. If the number of points within the threshold is equal to or greater than the predetermined number, the division is terminated, and this allows the element detection process to be performed for the two divided sets of point cloud data, respectively, based on the identified shape. On the other hand, if the number of points within the threshold is less than a predetermined number, the division should be repeated until the number is equal to or greater than the predetermined number.

For example, suppose that a trajectory T as shown in FIG. 19A is obtained by continuously tracing a straight line element E1 and a straight line element E2 with a finger respectively, and that point cloud data PC of the trajectory T as shown in FIG. 19B is obtained. At first, as shown in FIG. 19C, an optimal straight line FL and an optimal circle FC are fitted to the point cloud data PC, respectively, and evaluated by RANSAC. If, as a result of the evaluation, the number of points within the threshold is less than the predetermined number, the point cloud data PC is divided into point cloud data PC1 and point cloud data PC2, as shown in FIG. 19D. Next, the point cloud data PC1 is fitted to the optimal straight line FL1 and evaluated by RANSAC, and the point cloud data PC2 is fitted to the optimal straight line FL2 and evaluated by RANSAC. As a result, if the number of points within the threshold is equal to or greater than a predetermined number for both point cloud data, the division is terminated, and the element detection process can be performed for the two point cloud data, respectively, based on the identified shape.

Conversely, it is also possible to detect as a single element, even if it is divided into a plurality of parts and traced. For example, when each point of the point cloud data of the trajectory traced at the beginning is fitted to each shape, for each point, it is evaluated whether or not the residual with the model estimated by RANSAC is located within the threshold value in each shape. If the number of points within the threshold in any of the shapes is greater than or equal to a predetermined number, the shape of the point cloud data in question is temporarily identified. When the point cloud data of one or more trajectories traced consecutively thereafter is combined with the point cloud data of the trajectory traced initially and each point is fitted to each shape, for each point, it is evaluated whether or not the residual with the model estimated by RANSAC is located within the threshold value in each shape. If the number of points within the threshold in any of the shapes is greater than the number of points within the threshold when evaluated using point cloud data of fewer trajectories, the shape is identified by combining the point cloud data of two or more trajectories that have been traced consecutively. In this way, it is also possible to detect as a single element, even if it is divided into a plurality of parts and traced.

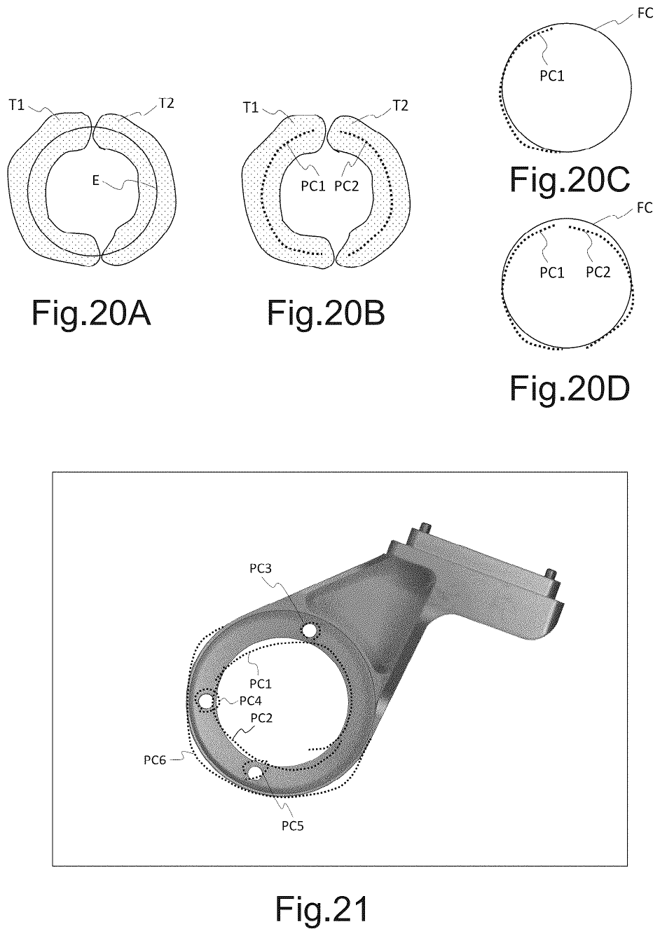

For example, suppose that trajectories T1 and T2 shown in FIG. 20A were obtained by tracing circular element E divided into two parts with a finger, and point group data PC1 and PC2 of trajectories T1 and T2 shown in FIG. 20B were obtained. In this case, as shown in FIG. 20C, if the number of points within the threshold value is equal to or greater than the predetermined number as a result of fitting the optimal circle FC only to the point cloud data PC1 and evaluating it by RANSAC, the shape of the point cloud data is temporarily identified as a circle or a circular arc. However, if the number of points within the threshold value obtained as a result of fitting the optimal circle FC by adding further point cloud data PC2 and evaluating it using RANSAC is greater than when only point cloud data PC1 is used, the combined shape of point cloud data PC1 and PC2 is identified as a circle, as shown in FIG. 20D.

The detection of edges and screen display may be performed upon termination of the input of the trajectory to the input unit 10 after it has started, or detection of undetected edges and screen display may be performed in real-time at each certain stretch of the trajectory during the ongoing input of the trajectory.

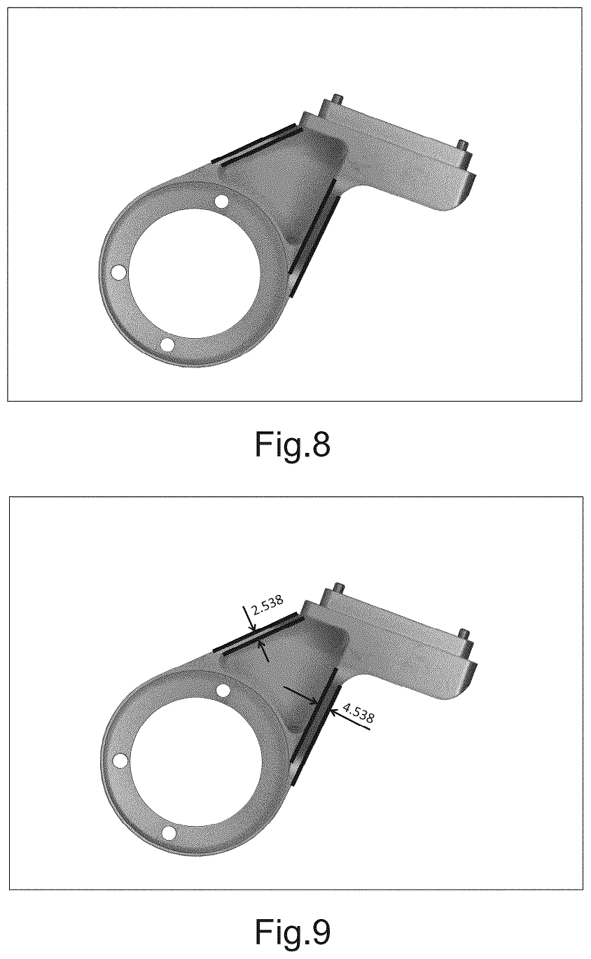

The input of the trajectory from the input unit 10 and the edge detection in the edge detection unit 41 are repeated until the edges necessary for the measurement of the desired measurement point are detected. For example, after detecting the edges of a measurement point as shown in FIG. 6, if the edges of the other measurement point are to be detected, by tracing that other measurement point on the image as shown in FIG. 7, the edges of that other measurement point will be detected as shown in FIG. 8.

For a plurality of elements, instead of processing the trajectory each time the trajectory input, processing may be performed after a plurality of trajectory inputs in batches.

For example, if six trajectories are input and point cloud data PC1 to PC6 corresponding to the first through sixth trajectories, respectively, are obtained as shown in FIG. 21, first, focusing on the first trajectory, the number of points for which the residuals with the model estimated by RANSAC are within a threshold value is determined using only the points in the point cloud data PC1. Then, using the point cloud data PC1 and PC2 for the first and second trajectories, the number of points within the threshold value is determined in the same manner. Then, using the point cloud data PC1 to PC3 of the first to third trajectories, the number of points within the threshold value is determined in the same manner. The number of points within the threshold is obtained in the same way, while increasing the number of trajectories until the point cloud data PC1 to PC6 of the first to sixth trajectories are used. The first element can then be detected by applying the aforementioned process to the point cloud data for the case with the largest number of points within the threshold. If a straight line or circle is traced at a time, the number of points within the threshold will generally be greatest when using only the point cloud data of the first trajectory. In other words, one element is detected based on one trajectory. On the other hand, if a single straight line or circle is traced in m portions, the number of points within the threshold value will generally be the greatest when using the point cloud data of the first to mth trajectory. In other words, one element is detected based on m trajectories. For example, if a circle is traced by two half-circle trajectories, it can still be detected as the circle.

After the first element is detected, the second and subsequent elements are detected using point cloud data other than the point cloud data used to detect the first element, in a manner similar to the detection of the first element. For example, if the first element is detected by the first and second trajectories, and then the second element is to be detected, the third trajectory is focused on, and the number of points for which the residuals with the model estimated by RANSAC are within the threshold value is determined using only the points in the point cloud data of the third trajectory. The number of points within the threshold is obtained in the same way, while increasing the number of trajectories until the point cloud data of the third to sixth trajectories are used. The second element can be detected by applying the aforementioned process to the point cloud data for the case with the largest number of points within the threshold.

If the element cannot be detected by this method, assuming that more than two elements are included in a single trajectory, the point cloud data may be divided and evaluated by RANSAC for each divided set of point cloud data, as described above, to attempt to extract more than two elements.

The measurement performing unit 42 performs measurements based on one or more edges detected by the edge detection unit 41. Measurement items such as length dimensions and angle dimensions may be specified at the time of performing the measurement, or they may be specified before the measurement is performed.

FIG. 9 shows an example of the measurement results when the measurement item is the length dimension between two edges, superimposed on the image showing the edge detection results in FIG. 8. Measurement and display of measurement results may be performed sequentially starting from the measurement point where the edges necessary for measurement of the measurement item have been detected, or may be performed for a plurality of measurement points collectively after the edges of the plurality of measurement points have been detected. Taking the case of FIGS. 5 to 8 as an example, in case the measurement and display of measurement results are performed sequentially, the measurement and display of measurement results are performed when two edges of a certain measurement point are detected, as shown in FIG. 6, and the measurement and display of measurement results of the other measurement point are performed when two edges of that other measurement point are detected, as shown in FIG. 8.

In the present invention, the control processing unit 4 may be constituted by a CPU, and each function may be realized by executing a program that describes the functions of the edge detection unit 41 and the measurement performing unit 42, as well as the functions to control the image capturing unit 3, the illumination unit 8, etc., by the CPU. The program may be read from memory unit 5 or from another storage medium. The control processing unit 4 and the memory unit 5 may be provided in the main body of the image measuring apparatus 1, or in a personal computer or other device that is communicatively connected to the main body of the image measuring apparatus 1.

According to the image measuring apparatus of the present invention described above, edges can be detected by an intuitive operation in which the operator traces the image displayed on the display, thereby reducing the workload of edge detection.

The present invention is not limited to the above embodiments and variations. The above-mentioned embodiments and variations are examples only, and anything having a configuration substantially the same as the technical idea described in the claims of the present invention and producing similar effects is included in the technical scope of the present invention. In other words, changes can be made as appropriate within the scope of the technical ideas expressed in the present invention, and forms with such changes and improvements are also included in the technical scope of the present invention.

What is claimed is:

1. An image measuring apparatus that captures an image of a measurement object and measures the dimensions of the measurement point of the measurement object by analyzing the image, comprising:
a display unit that displays the image of the measurement object;
an input unit that accepts input of the trajectory traced by an operator on the image displayed on the display unit;
an edge detection unit that detects an edge based on the traced trajectory on the image; and
a measurement performing unit that performs measurement based on one or more detected edges.

2. The image measuring apparatus according to claim 1, wherein the edge detection unit detects the edge that exists in the area along the centerline of the trajectory.

3. The image measuring apparatus according to claim 1, wherein the edge detection unit detects the edge that exists within the area surrounded by the trajectory.

4. The image measuring apparatus according to claim 1, wherein the edge detection unit detects the edge that is similar in shape to the shape of the trajectory.

5. The image measuring apparatus according to claim 4, wherein the edge detection unit determines whether or not the shape similar to the point cloud data of the trajectory is a straight line by least-squares fitting the straight line to the point cloud data of the trajectory and calculating RMSE (Root Mean Squared Error),
if it is determined that the shape similar to the point cloud data of the trajectory is not a straight line, determines whether the shape similar to the point cloud data of the trajectory is a circle or a circular arc by a least-squares fitting of a circle to the point cloud data of the trajectory and calculation of RMSE, and
if it is determined that the shape similar to the point cloud data of the trajectory is a circle or a circular arc, determines whether the shape similar to the point cloud data of the trajectory is a circle or a circular arc by calculating the distance between the center of gravity of the point cloud data of the trajectory and the center of the optimal circle, which is a circle that is least-squares fitted to the point cloud data of the trajectory.

6. The image measuring apparatus according to claim 5, wherein the point cloud data of the trajectory is the point cloud data of a thin line obtained by thinning the image of the trajectory using a thinning algorithm.

7. The image measuring apparatus according to claim 5, wherein if a shape similar to the point cloud data of the trajectory is identified as a straight line, then among the straight lines in a predefined detection area based on the trajectory in the image, straight lines whose angle with the optimal straight line, which is a least-squares fitted line to the point cloud data of the trajectory, is less than or equal to a predetermined threshold value are extracted,
among the extracted straight lines, a base straight line is determined based on a predefined rule, and
among the extracted straight lines other than the base straight line, those whose length of the perpendicular line descending from the midpoint to the extension of the base straight line is less than or equal to a predetermined threshold value are connected to the base straight line and the resulting straight line is detected as the element for edge detection.

8. The image measuring apparatus according to claim 5, wherein if a shape similar to the point cloud data of the trajectory is identified as a circle, then among circles in a predefined detection area based on the trajectory in the image of the measurement object, circles where the distance between the center of the circle and the center of the optimal circle is less than or equal to a predetermined threshold are extracted, and
a circle to be an element for edge detection is determined among the extracted circles based on a predefined rule.

9. The image measuring apparatus according to claim 5, wherein if a shape similar to the point cloud data of the trajectory is identified as a circular arc, or if a shape similar to the point cloud data of the trajectory is identified as a circle and there is no circle in the predefined detection area based on the trajectory for which the distance between the center of the circle and the center of the optimal circle is less than or equal to a predetermined threshold value, then among circular arcs in a predefined detection area based on the trajectory in the image of the measurement object, circular arcs where the distance between the center of the circle including the circular arc and the center of the optimal circle is less than or equal to a predetermined threshold value are extracted, then, among the extracted circular arcs, a base circular arc is determined based on a predefined rule, and
among the extracted circular arcs other than the base circular arc, those whose difference between the radius of the circle including the circular arc and the radius of the circle including the base circular arc is less than or equal to a predetermined threshold value are connected to the base circular arc and the resulting circular arc or circle is detected as the element for edge detection.

10. The image measuring apparatus according to claim 1, wherein the edge detection unit performs edge detection when the input of the trajectory to the input unit is terminated.

11. The image measuring apparatus according to claim 1, wherein the edge detection unit performs detection of undetected edges at each certain stretch of the trajectory during the ongoing input of the trajectory to the input unit.

12. The image measuring apparatus according to claim 1, wherein the display unit is a touch panel display integrated with the input unit.

13. The program that causes a computer to function as the image measuring apparatus as claimed in claim 1.
